(19) United States
(12) Patent Application Publication
(10) Pub. No.: US 2007/0017326 A1
(43) Pub. Date: Jan. 25, 2007

(54) Laser generator mounted on a fixed component of a handheld cutting device

(75) Inventors: Charles Keith Long, Seneca, SC (US); Kenneth M. Brazell, (US); Steve Hicks, Greenville, SC (US)

Correspondence Address: BRINKS HOFER GILSON & LIONE, P.O. BOX 10395, CHICAGO, IL, 60610, US

(73) Assignee: One World Technologies Limited

(21) Appl. No.: 11/186,114

(22) Filed: Jul. 20, 2005

(51) Int. Cl. B23D 47/00

(52) U.S. Cl. 83/13; 83/520; 30/391

(57) ABSTRACT

A cutting device, such as a circular saw, is disclosed with a laser-generating alignment mechanism. The alignment mechanism is mounted on a fixed component of the cutting device, such as a fixed linkage between the base of the device and the upper blade guard, thereby eliminating any significant variation in the length of the laser beam and resulting in a more accurate cut. A method of generating an accurate cut is also provided. The method includes placing a cutting device, such as a circular saw, adjacent to a workpiece and cutting the workpiece along a laser beam created by a laser generator mounted on a fixed component of the cutting device, such as a fixed linkage between the base of the device and the upper blade guard.

### BACKGROUND

1. Technical Field

The present invention generally relates to cutting devices. More specifically, the illustrative embodiments of the present invention relate to handheld cutting devices having a laser alignment mechanism for ensuring the accurate cutting of a workpiece along a path.

2. Background Information

Traditionally, to ensure an accurate cut when utilizing a handheld cutting device, the operator of the device would scribe a line on the surface of a workpiece and then use this line as a guide along which to cut. Alternatively, the cutting device would contain a flange that slid against a guide to direct the blade along the contour of the guide. These techniques have several disadvantages. First, if the scribed line or the guide is not straight, the operator may generate an inaccurate cut. Likewise, if the scribed line is too faint or the operator is unskilled, the operator may find it difficult to precisely follow the line, thereby resulting in an inaccurate cut.

To eliminate these disadvantages and the need for the additional step of creating a line on the surface of a workpiece or building and attaching a guide to the surface of the workpiece, the cutting device itself may be provided with a mechanism that may be used to properly align the cutting device with a target guide. For example, such a mechanism may project a laser beam onto the workpiece and serve as a guide for making the cut, as disclosed in U.S. Pat. No. 5,675,899 (Rotary saw with laser beam alignment).

Prior laser alignment devices are mounted on a movable component of the cutting device, such as the blade guard or the base plate of the cutting device. See, e.g., U.S. Pat. No. 5,675,899, U.S. Pat. No. 6,497,168, and German Publication DE 39 22 849 A1. When the position of the movable component is adjusted, for example by adjusting the depth of the cut or the bevel angle of the cutting device, the position of the laser alignment device also changes. Likewise, the length of the laser beam emitted from the laser alignment device changes. If the length of the laser beam is too great, the operator of the cutting device tends to oversteer, resulting in a cut that is misaligned. On the other hand, if the laser beam is too short, the operator of the cutting device is required to focus on the area of the workpiece immediately ahead of the blade, which may also result in a misaligned cut.

Therefore, there is a need for a handheld cutting device with a laser-generating alignment mechanism that provides the operator with a guide along which to cut, while eliminating substantial variations in length of the laser beam and the cutting inaccuracies caused thereby when the cutting device is adjusted. Similarly, there is a need for a method of generating an accurate cut with a handheld cutting device having a laser-generating alignment mechanism.

### BRIEF SUMMARY

In general, the present invention provides a handheld cutting device with a laser generator mounted on a fixed component of the cutting device. In this invention, the laser generator emits a beam that projects onto a workpiece an alignment line having a length that does not change significantly, even when the positions of the moving components are varied, thereby allowing the operator to easily create an accurate cut. In one embodiment of the invention, the cutting device is a circular saw, and the laser generator is mounted on a fixed linkage between the base and the upper blade guard of the saw.

Another aspect of the present invention is directed to a method of generating an accurate cut. The method includes placing a handheld cutting device adjacent to a workpiece and cutting the workpiece along an alignment line created by a laser generator mounted on a fixed component of the cutting device. In one embodiment, the method includes utilizing a circular saw with a laser generator mounted on a linkage between the base of the saw and the upper blade guard. The operator of the cutting device may also adjust the position of the saw without significantly affecting the length of the alignment line created by the laser generator or the accuracy of the cut.

Additional features and advantages of the present invention will be apparent to one of ordinary skill in the art from the drawings and detailed description of the preferred embodiments below.

### BRIEF DESCRIPTION OF THE DRAWINGS

FIG. 1 is a perspective view of one embodiment of the handheld cutting device of the present invention;

FIG. 2 is a side view of the embodiment of the invention shown in FIG. 1;

FIG. 3 is a view similar to FIG. 2, except showing the cutting tool adjusted to a more shallow cutting depth;

FIG. 4 is a front view of the embodiment of the invention shown in FIG. 1; and

FIG. 5 is a view similar to FIG. 4, except showing the cutting tool adjusted to a bevel angle α.

### DESCRIPTION OF THE PREFERRED EMBODIMENTS

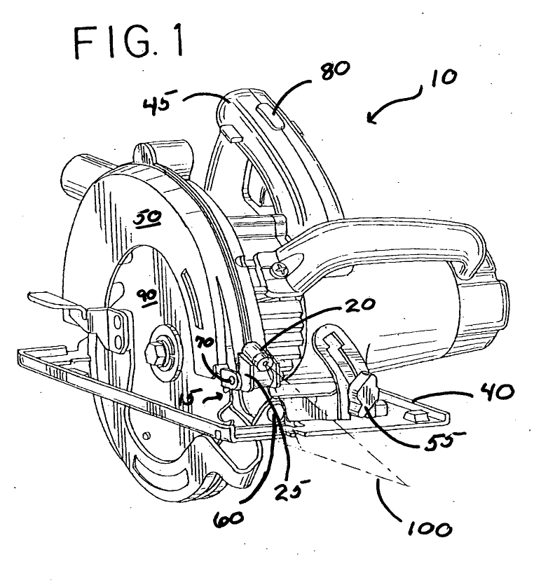

FIGS. 1-5 show one embodiment of the handheld cutting device of the present invention. In this embodiment, the cutting device 10 is a circular saw. The cutting device 10, however, may be any cutting device having a fixed component 15 onto which a laser generator 20 may be mounted, such as a radial arm saw, chop saw, miter saw, power motor box, table saw, wet saw, or the like. The laser generator 20 may be mounted directly on the fixed component 15 or may be placed within or on a separate mounting assembly 25, which in turn is mounted on a fixed component 15 of the cutting device 10. The laser generator 20 or mounting assembly 25 may be attached to the cutting device 10 by any known means, such as welding, adhesive, velcro, screws, fasteners, clasps, clamps, or the like. In FIGS. 1-5, the laser generator 20 is mounted on a separate structure 25, which in turn is mounted on a fixed bracket 15 linking the base 40 of the cutting device 10 to the upper blade guard 50.

The laser generator 20 of the embodiment of the present invention depicted in FIGS. 1-5 is shown as a simple module that projects an alignment line 100 onto a workpiece to be cut. Any type and style of laser generator 20 may be used. For example, the laser generator 20 may be of the type used in pointing devices or it may include a quartz laser diode that generates a laser beam in the visible light wave range (see, e.g., German Publication DE 39 22 849 A1), a laser device in which the laser beam generated therefrom is reflected onto a workpiece by a multi-sided member (see, e.g., U.S. Pat. No. 6,497,168), a laser module that projects a laser beam through a plano-convex lens (see, e.g., U.S. Pat. No. 5,446,635), or a laser beam discharge tube that may be rotated through a slot in the housing to change the orientation of the laser beam (see, e.g., U.S. Pat. No. 5,675,899).

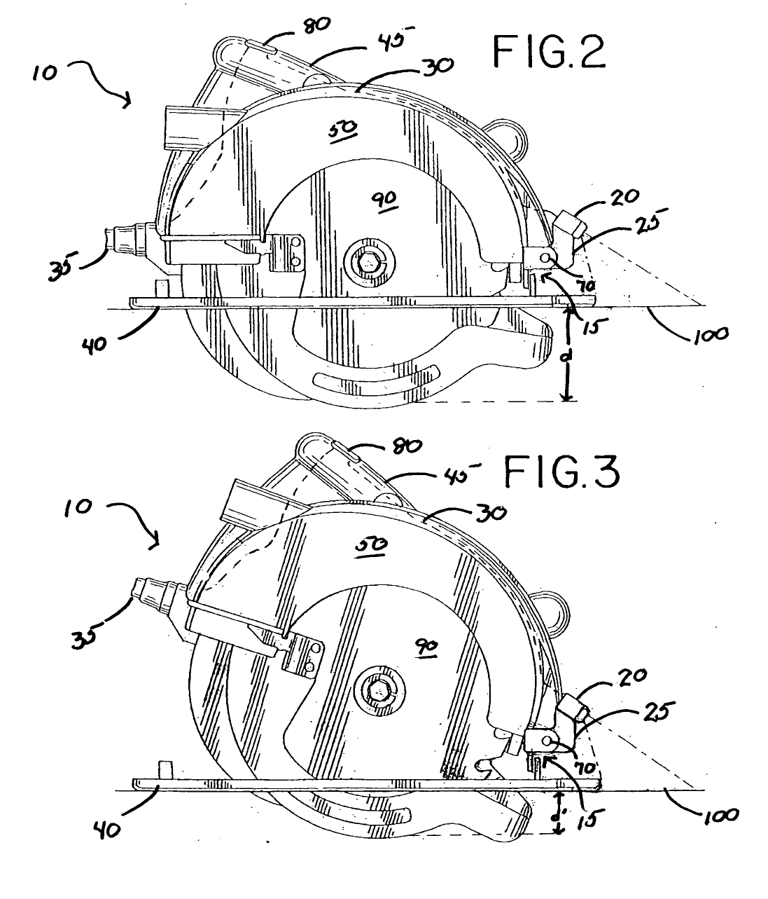

The laser generator 20 may be powered by a battery or by the cutting device's main power supply, or it may generate electricity automatically by rotating a shaft of the cutting device motor, for example, as disclosed in U.S. Pat. No. 6,584,695. A typical “on-off” switch 80 may be placed in a convenient location to selectively control the supply of power to the laser generator 20. In the embodiment shown in FIGS. 2 and 3, the “on-off” switch 80 is located on the handle 45 of the cutting device 10, and the laser generator 20 is powered by the main power supply of the cutting device 10, as indicated by the dashed line 30 running from the laser generator 20 to the main power supply cord 35. Other battery-powered laser generators may be turned on and off independently, without engaging the main power supply of the cutting device 20. Optionally, the laser generator may include a focusing lens that aligns with an aperture for focusing the laser beam emitted from the generator.

In the embodiment shown in FIGS. 1-5, the laser generator 20 is attached to a fixed bracket 15 linking the base 40 of the saw 10 to the upper blade guard 50. The laser generator 20, however, may be mounted on any fixed component of the saw or other handheld cutting device 10 and may be mounted in a manner that facilitates ready disconnection of the laser generator 20 from the cutting device 10, if desired. Both the base 40 and the upper blade guard 50 are movable components of the saw and may be repositioned to achieve a desired bevel angle and cutting depth, respectively. The base 40 rotates about pivot 60 and may be positioned at a desired bevel angle α by moving the adjustment knob 55, as shown in FIG. 5. The upper blade guard 50 rotates about pivot 70 and may be positioned to achieve a desired cutting depth d or d′, as shown in FIGS. 2 and 3, respectively.

Mounting the laser generator 20 on a fixed component 15 of the handheld cutting device 10 eliminates at least two problems associated with conventional laser alignment devices. First, on some cutting devices that contain laser alignment mechanisms mounted on a moving component of the cutting device (such as the upper blade guard), adjusting the cutting depth to a shallow depth setting causes the length of the laser beam to be too short, thereby requiring the operator to focus on a laser beam that extends only immediately in front of the cutting blade. In addition, as the blade on the cutting device approaches the workpiece, the laser beam tends to shift and become wider. Second, on some cutting devices that contain laser alignment mechanisms mounted on a moving component of the cutting device (such as the base), adjusting the bevel angle causes the laser beam to become too long, thereby causing the operator to oversteer. Adjusting the bevel angle may also cause the laser beam to shift and increase in thickness. Mounting the laser generator 20 on a fixed component 15 of the cutting device 10 eliminates these problems and prevents cutting inaccuracies by assuring that the length of the alignment line 100 projected onto the workpiece does not change significantly when adjustments are made to the cutting depth d or bevel angle α of the cutting device 10. Desirably, the length of the alignment line changes less than about 8 mm. More desirably, the length changes less than about 6 mm. Even more desirably, the length changes less than about 2 mm.

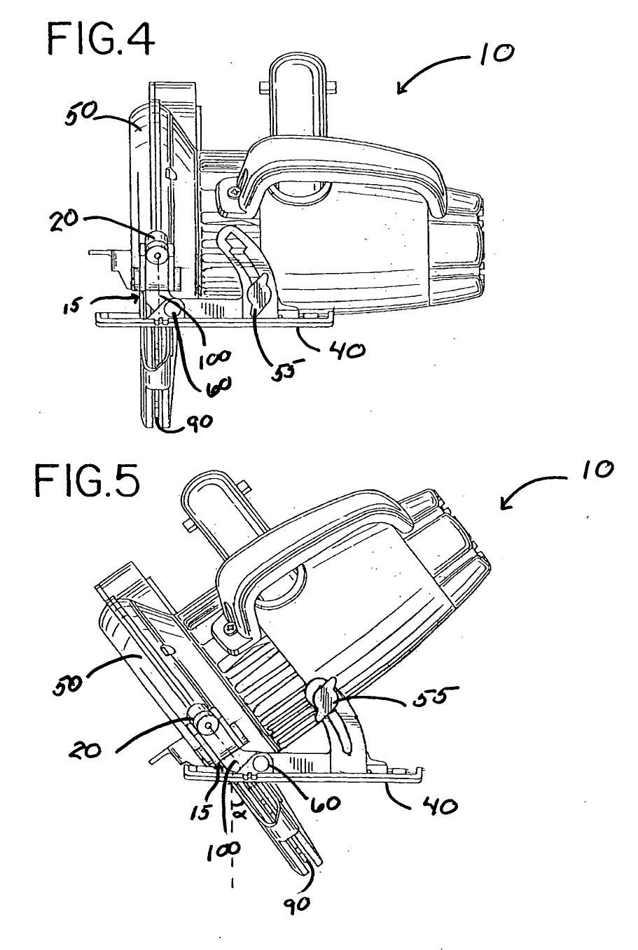

As shown in FIGS. 2 and 3, respectively, the cutting depth of the handheld cutting device 10 may be adjusted from d to d′ without a significant change in the length of the alignment line 100 projected onto the workpiece, thereby allowing for a more accurate cut. Similarly, as shown in FIGS. 4 and 5, respectively, the bevel angle of the cutting device 10 may be adjusted from a position in which the cutting tool 90 is perpendicular to the base 40 to a position in which the cutting tool 90 is at a desired angle α from the base 40, without a significant change in the length of the alignment line 100 projected onto the workpiece.

In the embodiments shown in FIGS. 1-5, the laser generator 20 is aligned with the cutting portion 90 of the handheld cutting device 10. To facilitate alignment, the laser generator 20 may be rotatable in any direction. A rotatable laser generator may also provide the operator the flexibility to direct the laser beam upwards to a target guideline on a ceiling, for example. In the embodiment shown in FIGS. 1-5, the laser generator 20 is directed downward toward the workpiece and is aligned with the cutting tool 90 so that the laser beam 100 strikes the workpiece along the plane of the cutting tool 90. The operator of the saw 10 may then direct the saw 10 along the laser beam 100 to generate a straight and accurate cut.

The laser generator 20 may be aligned with one side of the blade of the handheld cutting device 10. Alternatively, a laser generator that produces a laser beam sized to exactly match the thickness of the blade may be used so that the operator has the flexibility of aligning his or her cut mark with either side of the laser beam. Multiple laser beam widths and power options are available.

Another aspect of the invention is directed to a method of generating an accurate cut. The method includes: (1) providing a handheld cutting device 10 having a cutting tool 90 and having a laser generator 20 mounted on a fixed component 15 of the cutting device 10, where the generator 20 produces a laser beam 100 having a length that does not significantly change when the cutting device 10 is repositioned; (2) aligning the laser beam 100 with the cutting tool 90; (3) placing the cutting device 10 adjacent a workpiece; and (4) cutting the workpiece along the laser beam 100.

In one embodiment of the method of the present invention, the method includes adjusting the cutting depth d or the bevel angle α of the handheld cutting device 10 without significantly changing the length of the alignment line 100 emitted from the laser generator 20. The constant length of the alignment line 100 permits the user to easily follow the line 100 with the cutting device 10 and generate a smooth, straight cut. Desirably, a constant length is obtained by attaching the laser generator 20 to a fixed component 15 of the cutting device 10, such as a fixed linkage between the base 40 of the cutting device 10 and the upper blade guard 50.

Desirably, the cutting device 10 used in the method of the present invention is a circular saw, the cutting tool 90 is a saw blade, and the workpiece is a piece of wood. As explained above, the alignment line 100 may be aligned with either side of the blade or it may have a thickness corresponding exactly to the thickness of the blade.

It is intended that the foregoing detailed description be regarded as illustrative rather than limiting, and that it be understood that it is the following claims, including all equivalents, that are intended to define the spirit and scope of this invention.

1. A cutting device comprising a bevel adjustment or depth adjustment, a fixed component, a laser generator mounted to said fixed component of said cutting device, said laser generator emitting a beam that projects onto a workpiece an alignment line having a length that does not significantly change upon repositioning of one of said bevel adjustment or depth adjustment, and wherein said cutting device is a handheld cutting device.

2. The cutting device of claim 1 wherein said cutting device is a circular saw.

3. The cutting device of claim 2 wherein said cutting device further comprises a first component and a second component, said first component and said second component being capable of relative movement that results in the repositioning of one of said bevel adjustment or said depth adjustment, and wherein said fixed component is located between said first component and said second component.

4. The cutting device of claim 3 wherein said first component comprises a base.

5. The cutting device of claim 3 wherein said second component comprises an upper blade guard.

6. The cutting device of claim 3 wherein said fixed component comprises a linkage, said first component comprises a base and said second component comprises an upper blade guard.

7. The cutting device of claim 1 wherein the length of the alignment line does not significantly change upon repositioning of said bevel adjustment and said depth adjustment.

8. The cutting device of claim 1 further comprising a cutting tool, wherein said alignment line is aligned with said cutting tool.

9. A circular saw comprising:
a cutting tool;
a first component and a second component, wherein said first component and said second component are capable of relative movement;
a fixed linkage between said first component and said second component; and
a laser generator mounted to said fixed linkage that projects onto a workpiece an alignment line having a length that does not significantly change upon adjusting a cutting depth adjustment or adjusting a bevel angle adjustment of said saw, wherein said alignment line is aligned with said cutting tool.

10. The circular saw of claim 9 wherein said first component comprises a base and said second component comprises an upper blade guard.

11. The circular saw of claim 9 wherein said alignment line length does not significantly change upon adjusting said cutting depth adjustment and adjusting said bevel angle adjustment.

12. The circular saw of claim 9 wherein said alignment line length changes less than about 6 mm.

13. The circular saw of claim 9 wherein said alignment line length changes less than about 2 mm.

14. A method of generating an accurate cut comprising:
providing a handheld cutting device comprising (a) a cutting tool and (b) a laser generator mounted on a fixed component of said cutting device wherein said generator projects onto a workpiece an alignment line having a length that does not significantly change upon repositioning of said cutting device;
placing said cutting device adjacent to a workpiece; and
cutting said workpiece along said laser alignment line.

15. The method of claim 14 wherein said repositioning comprises adjusting either a cutting depth or bevel angle of said cutting device.

16. The method of claim 14 wherein said cutting device is a circular saw.

17. The method of claim 14 wherein said cutting tool is a saw blade.

18. The method of claim 14 wherein said fixed component comprises a linkage between a first component and a second component, said first component and said second component being capable of relative movement that results in the adjustment of either a cutting depth or bevel angle.

19. The method of claim 18 wherein said first component comprises a base and said second component comprises an upper blade guard.

20. The method of claim 19 wherein said length changes less than about 8 mm.
